(19) United States
(12) Patent Application Publication
(10) Pub. No.: US 2009/0177712 A1
(43) Pub. Date: Jul. 9, 2009

(54) Digital data Recording device

(75) Inventors: Yoshihiro Shimizu, Yokohama (JP); Haruhiko Sawajiri, Atsugi (JP)

Correspondence Address: Juan Carlos Marquez;Reed Smith LLP, Suite 1400, 3110 Fairview Park Drive, Falls Church, VA, 22042-4503, US

(73) Assignee: Hitachi, Ltd

(21) Appl. No.: 12/318,458

(22) Filed: Dec. 30, 2008

(30) Foreign Application Priority Data
Jan. 8, 2008 (JP) JP 2008-001424

(51) Int. Cl. G06F 17/30; G06F 12/14

(52) U.S. Cl. 707/202; 707/204; 707/E17.005; 707/E17.007; 707/10; 713/193

(57) ABSTRACT

Provided is a digital data recording device capable of efficiently backing up media data of digital data requiring copyright protection and personal information protection within a range of the copyright holder's permission. The digital data recording device includes a record control unit for recording a media file configured by a media data file and a media management file containing decryption key information of the media data file to a recording device, backing up the media data file or the media management file to the recording device or a removable recording device, and restoring the media data file or the media management file backed up in the recording device or the removable recording device.

### CROSS-REFERENCE TO RELATED APPLICATION

The present application claims priority from Japanese Patent Application No. JP 2008-001424 filed on Jan. 8, 2008, the content of which is hereby incorporated by reference into this application.

### TECHNICAL FIELD OF THE INVENTION

The present invention relates to a digital data recording device which records copyright-protected digital data such as video, audio, images, texts, map data, game data. More particularly, the present invention relates to backup of digital data.

### BACKGROUND OF THE INVENTION

HD DVD (Trademark) and Blu-ray Disc (Trademark) appeared in 2006, and iVDR (Information Versatile Disk for Removal usage) which is a removable hard disk drive appeared in 2007. Like this, it has been becoming easier for anybody to record large-volume media data.

In addition, Digital Terrestrial Television broadcasting has been launched since 2003, and for the future, IP (Internet Protocol) broadcasting is also being planned because diffusion of high-speed communication networks has been accelerated.

Further, because in-vehicle terminals and game consoles have made sophisticated, media data which users record are expanded not only for those such as video, audio, images, texts, but also map data and game software. Those media data are expected to be larger in volume year by year.

Because of having more opportunities for recording such a media data with variety and large volume, there arise needs for backing up these media data. However, these kinds of media data often have merchandise value or include personal information, and they are provided for profit and sometimes are legally protected by copyright law and so forth.

On the other hand, media data of digital data are unlimitedly replicable because of the property of digital data. Accordingly, to protect copyrights and personal information, some countermeasures against illegal copy have been provided on copy of media data.

There have been known some ways to handle media data such as allowing copy for predetermined times, allowing no copy, and allowing data movement to external recording devices.

In such a way, there are users' needs for backing up media data and also its copyright holders' and users' needs for limiting replication of media data to protect their copyrights and personal information.

As a conventional backup method for media data, like Japanese Patent Application Laid-Open Publication No. 2007-249077 (Patent Document 1), there is a method of backup by utilizing DTCP/IP (Digital Transmission Contents Protection over IP) standard to transmit media data to an external device safely and encrypt the media data on a plurality of recording devices inside of the external device by using a key unique to the external device.

### SUMMARY OF THE INVENTION

Meanwhile, it has been becoming popular to put hard disk drives which were used mainly for personal computers into use for AV equipments such as video recorders and digital TVs, in-vehicle terminals, and game consoles.

As an example, there is the iVDR. The iVDR has features as follows.

1. A small-sized and light removable hard disk drive or a terminal-embedded hard disk drive.

2. Capable of large-volume recording and high-speed random access while being removable.

3. Compatible with SAFIA (Security Architecture For Intelligent Attachment device) to realize copyright protection and personal information protection for media data.

According to the above features, it is possible to easily carry large-volume media data requiring copyright protection and personal information protection and to conveniently handle them by using high-speed random access. Here, pay attention to the third feature. SAFIA has features as follows.

A. Encrypted media data files and media management files containing decryption keys of the encrypted media data files are independently managed.

B. Media management file transfer function based on PKI (Public Key Infrastructure) including two-way authentication and revoke processing.

C. Function for protecting media management files from illegal access.

D. Flexible contents use management function by two-step control including an output control from a storage device and a reproducing control in a reproducing device.

E. Move (movement of contents between storage devices) function.

According to the above features, as well as protecting copyrights and personal information of media data, it is possible to realize a distribution of digital contents in which the compensation can be also paid to each use of digital data, called “super-distribution”.

In Patent Document 1 described above, while media data is backed up in a plurality of hard disk drives inside of one backup device, there is a risk for a destroy of original data and backup data of the media data at the same time when the backup device itself is crashed.

Accordingly, an object of the present invention is to provide a digital data recording device capable of efficiently performing backup of media data of digital data requiring copyright protection and personal information protection to a plurality of backup devices (recording devices) and removable recording devices within a range of the copyright holder's permission by using the features of iVDR and SAFIA.

The above and other objects and novel characteristics of the present invention will be apparent from the description of the present specification and the accompanying drawings.

The typical ones of the inventions disclosed in the present application will be briefly described as follows.

More particularly, a typical one of the present invention is to provide a record control unit which records a media file in a recording device, the media file being formed by an encrypted media data file that is digital contents main body and a media management file containing decryption key information of the media data file, which backups the media data file or the media management file in a recording device or a removable recording device, and which restores the media data file or the media management file backed up in the recording device or the removable recording device.

The effects obtained by typical aspects of the present invention will be briefly described below.

More particularly, an effect obtained by the typical aspects is to allow users for efficiently backing up media files such as video, audio, images, texts, map data, game data within a range of its copyright holder's permission.

### BRIEF DESCRIPTIONS OF THE DRAWINGS

FIG. 1 is a configuration diagram showing a configuration of a digital data recording device according to a first embodiment of the present invention;

FIG. 2 is a configuration diagram showing a data configuration of a media file of the digital data recording device according to the first embodiment of the present invention;

FIG. 3 is an explanatory diagram for describing a backup processing of the media file of the digital data recording device according to the first embodiment of the present invention;

FIG. 4 is an explanatory diagram for describing a backup processing by dividing the media file of the digital data recording device according to the first embodiment of the present invention;

FIG. 5 is an explanatory diagram for describing a backup processing of a media file of a digital data recording device according to a second embodiment of the present invention; and

FIG. 6 is a flow chart showing a backup processing of the media file of the digital data recording device according to the second embodiment of the present invention.

### DESCRIPTIONS OF THE PREFERRED EMBODIMENTS

Hereinafter, embodiments of the present invention will be described in detail with reference to the accompanying drawings. Note that, components having the same function are denoted by the same reference symbols throughout the drawings for describing the embodiment, and the repetitive description thereof will be omitted.

### First Embodiment

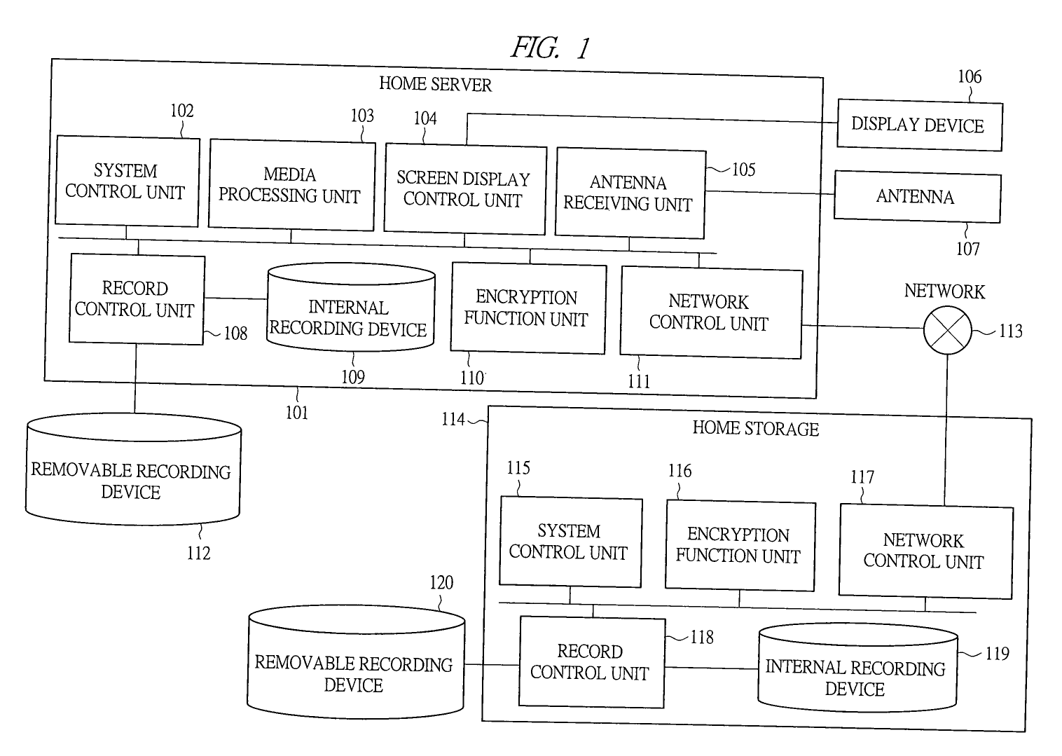

A configuration of a digital data recording device according to a first embodiment of the present invention will be described with reference to FIG. 1. FIG. 1 is a configuration diagram showing the configuration of the digital data recording device according to the first embodiment of the present invention.

In FIG. 1, a home server 101 which is a digital data recording device and a home storage 114 which is a digital data recording device are connected to a network 113. The network 113 may be connected to the Internet etc.

First, the home server 101 will be described.

The home server 101 is configured by a system control unit 102, a media processing unit 103, a screen display control unit 104, an antenna receiving unit 105, a record control unit 108, an internal recording device 109, an encryption function unit 110, and a network control unit 111.

The system control unit 102 performs control of the home server 101. Although not shown, the system control unit 102 performs also a user input processing by a remote controller and an input button control. The internal recording device 109 or the removable recording device 112 records a media file.

Hereinafter, it is assumed that encrypted and compressed video data is recorded in the media file. The encrypted and compressed video data recorded in the internal recording device 109 or the removable recording device 112 is read by the record control unit 108, and the video data's cryptography is decrypted by the encryption function unit 110, and further, the video data is converted to uncompressed video data by the media processing unit 103.

The uncompressed video data is displayed on a display device 106 by the screen display control unit 104.

Further, encrypted and compressed video data sent via the antenna receiving unit 105 from an antenna 107 or encrypted and compressed video data inputted to the network control unit 111 via the network 113 from the home storage 114, the Internet, etc. are subjected to an encryption processing by the encryption function unit 110, and recorded in the internal recording device 109 or the removable recording device 112 via the record control unit 108.

Next, the home storage 114 will be described.

The home storage 114 is configured by a system control unit 115, an encryption function unit 116, a network control unit 117, a record control unit 118, and an internal recording device 119.

The system control unit 115 performs control of the home storage 114. Although not shown, the system control unit 115 also performs a user input processing by a remote controller and an input button control. Encrypted and compressed video data recorded in the internal recording device 119 or the removable recording device 120 is read by the record control unit 118, and then subjected to an encryption processing by the encryption function unit 116 as needed, and sent out to the network 113 via the network control unit 117.

Further, encrypted and compressed video data inputted to the network control unit 117 via the network 113 from the home server 101 or the Internet, etc. is subjected to an encryption processing by the encryption function unit 116 and recorded in the internal recording device 119 or the removable recording device 120 via the record control unit 118.

Next, data handling of media files in respective recording devices will be described.

Media files in the removable recording device 112 are written in the internal recording device 109 by the record control unit 108 and the encryption function unit 110. Reversely, media files in the internal recording device 109 are also written in the removable recording device 112 by the record control unit 108 and the encryption function unit 110.

In addition, the internal recording device 119 and the removable recording device 120 which are embedded in or connected to the home storage 114 are also capable of mutual read and write of media files.

Further, media files in the removable recording device 112 can be read from and written to the internal recording device 119 via the record control unit 108, the encryption function unit 110, the network control unit 111, the network 113, the network control unit 117, the record control unit 118, and the encryption function unit 116.

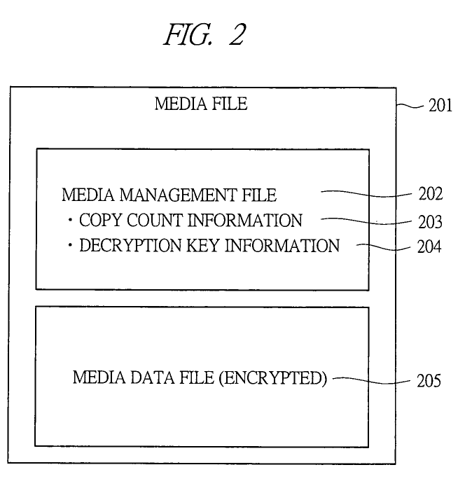

In the same manner, the internal recording device 109, the removable recording device 112, the internal recording device 119, and the removable recording device 120 are capable of mutual read and write. In the following, a backup processing of media files using the mutual read and mutual write will be described with reference to FIG. 2 to FIG. 4.

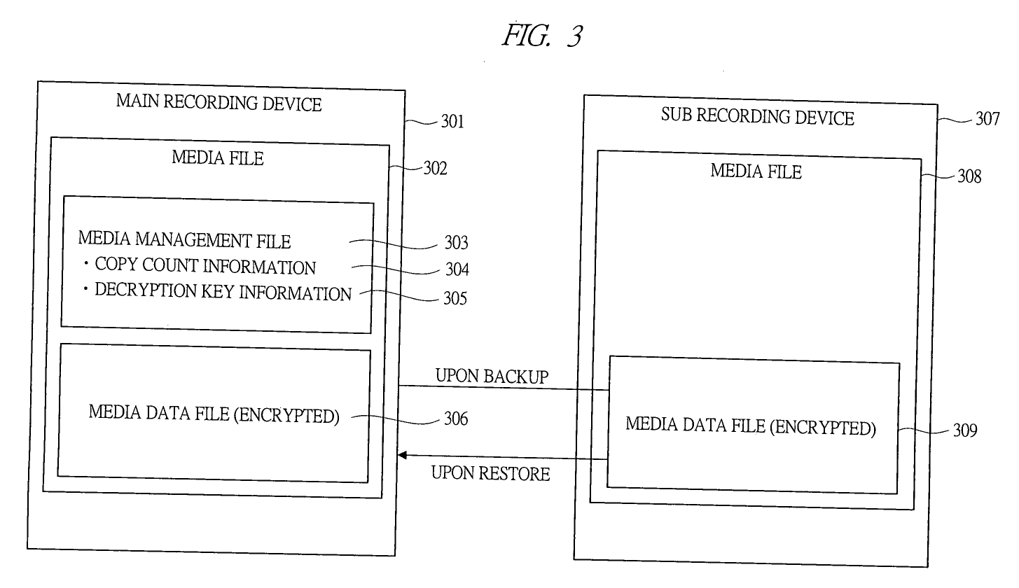

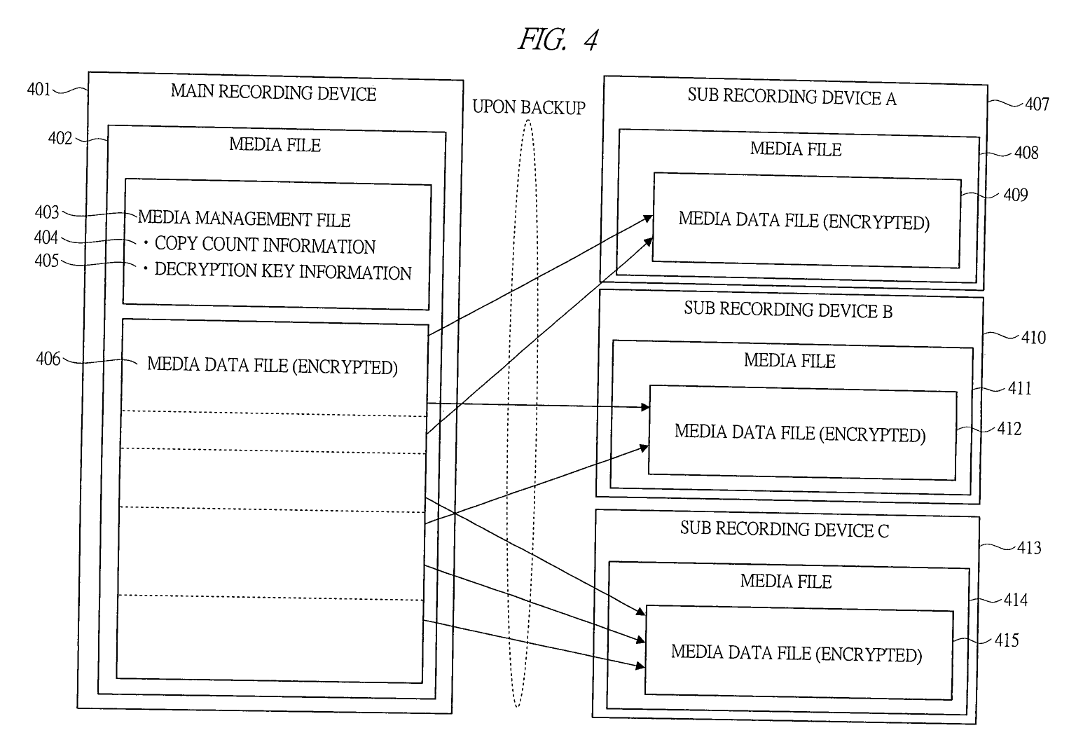

FIG. 2 is a configuration diagram showing a data configuration of a media file of the digital data recording device according to the first embodiment of the present invention, FIG. 3 is an explanatory diagram for describing the backup processing of the media file of the digital data device according to the first embodiment of the present invention, and FIG. 4 is an explanatory diagram for describing a backup processing by dividing the media file of the digital data recording device according to the first embodiment of the present invention.

In FIG. 2, a media file 201 is configured by a media data file 205 and a media management file 202. The media data file 205 is encrypted video data.

The media management file 202 is a management file regarding to the media data file 205, and contains a copy count information 203 indicating the number of copyable times of reproducible files and a decryption key information 204 being information for decrypting an encryption of the media data file 205.

Although not shown, the media management file 202 may contain names of contents, dates of recording, language information of sub (secondary) audio, etc. which are contained in the media data files. Further, one recording device can contain a plurality of media files.

First, the backup processing will be described. In the following, a recording device of a digital data recording device to hold media files to be backed up will be called a “main recording device”, and a recording device of a digital data recording device to stock backup data will be called a “sub recording device”.

In FIG. 3, only a media data file 306 of a media file 302 inside a main recording device 301 is copied to a media data file 309 inside a sub recording device 307. The media data file 309 is encrypted, and a media management file 303 is required to decrypt the media data file 309. The media management file 303 containing the copy count information 304 and the decryption key information 305 is not copied to a sub recording device 307.

Therefore, the media data file 309 cannot be reproduced when only the media data file 309 is copied to the media file 308 inside the sub recording device 307, so that the media data file 306 of the media file 302 inside the main recording device 301 can be backed up with protecting rights of its copyright holder.

Next, a restore processing will be described.

In FIG. 3, the backed up media data file 309 of the media file 308 inside the sub recording device 307 is pulled back to the media data file 306 of the media file 302 inside the main recording device 301 to restore.

In addition, while the media data file 306 is backed up to the media file 308 inside the one sub recording device 307 in FIG. 3, a media data file 406 of a media file 402 inside a main recording device 401 may be arbitrary divided (for example, media data files 409, 412, and 415) to be backed up as divided or overlapped in media files 408, 411, and 414 in a plurality of sub recording devices, that is, a sub recording device A407, a sub recording device B410, and a sub recording device C413.

If the media file 402 is backed up as divided and overlapped in the media files 408, 411, and 414, even when any sub recording device is broken, a risk of disabling restore of the media data file 406 is reduced.

The divided media data file is pulled back to the media data file 406 inside the main recording device 401 by restore.

The main recording device 401 shown in FIG. 4 corresponds to either one of the internal recording device 109, the removable recording device 112, the internal recording device 119, or the removable recording device 120 shown in FIG. 1.

The sub recording device A407, the sub recording device B410, and the sub recording device C413 shown in FIG. 4 are one or more recording devices other than main recording devices among the internal recording device 109, the removable recording device 112, the internal recording device 119, and the removable recording device 120 shown in FIG. 1.

As described above, in the present embodiment, the media file 201 is configured by the media data file 205 and the media management file 202, and the media data file 205 is backed up, so that the user can efficiently back up a media file such as video, audio, images, texts, map data, and game data within a range of its copyright holder's permission.

### Second Embodiment

While backup of the media data file 205 shown in FIG. 2 has been described, a second embodiment is for backup of the media management file 202 shown in FIG. 2. A configuration of a digital data recording device of the present embodiment is same with the configuration of the first embodiment shown in FIG. 1.

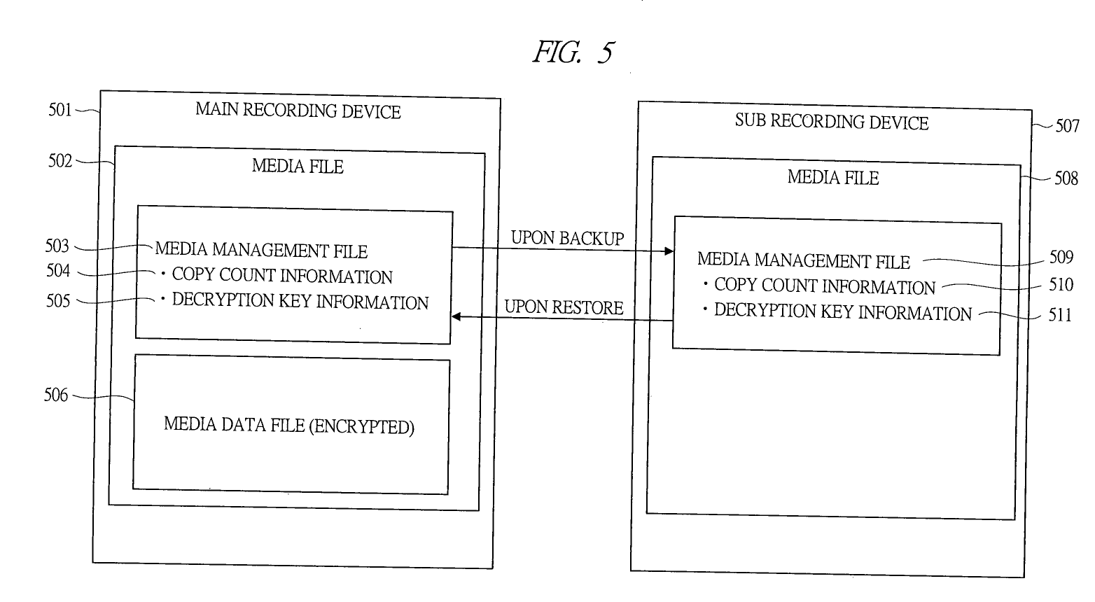

Next, with reference to FIG. 5, a backup processing of media files in a digital data recording device according to the second embodiment of the present invention will be described. FIG. 5 is an explanatory diagram for describing the backup processing of media files in the digital data recording device according to the second embodiment of the present invention.

In FIG. 5, a media management file 503 containing copy count information 504 and decryption key information 505 of a media file 502 inside a main recording device 501 is copied to a media management file 509 of a media file 508 inside a sub recording device 507. A media data file 506 of the media file 502 is not copied.

Upon this copying, the copy count information 504 or the value of that in the media management file 503 of the media file 502 inside the mains recording device 501 is reduced, and new copy count information 510 having copy count information of the reduced volume/value is written to the media management file 509 of the media file 508 inside the sub recording device 507. The decryption key information 505 of the media file 502 inside the main recording device 501 is copied to decryption key information 511 of the media file 508 inside the sub recording device 507 as it is.

For example, in the case where the copy count information 504 indicates 9 times and the number of copy count to be reduced is 4 times, the volume/value of copy count information 510 becomes to indicate 5 times. Note that, the number of copy count to be reduced can be set beforehand or set by a user.

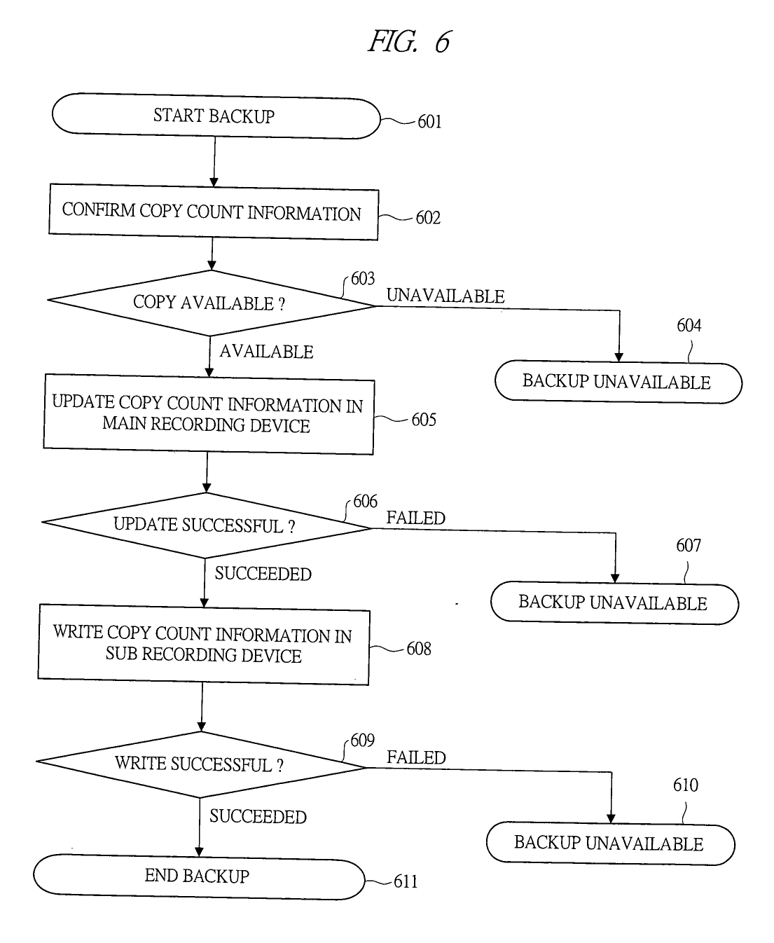

Next, with reference to FIG. 6, the backup processing of a media file of the digital data recording device according to the second embodiment of the present invention will be described. FIG. 6 is a flowchart showing the backup processing of a media file of the digital data recording device according to the second embodiment of the present invention.

First, the backup processing is started at start backup 601, and the copy count information 504 of the media file 502 inside the main recording device 501 is confirmed at confirm copy count information 602.

When the copy count information is a value which cannot be copied (for example, 0) at copy-availability 603, it proceeds to backup-unavailable 604.

When the copy count information 504 of the media file 502 inside the main recording device 501 is a value which can be copied (for example, 4 or larger if the number of copy count to be reduced is 4 times), the copy count information 504 of the media file 502 inside the main recording device 501 is reduced at update copy count information in main recording device 605.

Note that, the operation to reduce the copy count information 504 is required to be implemented to have tamper resistant by encrypting and the like with considering risks of hacking etc. Update availability of the copy count information 504 is confirmed at update success 606, and when the update is failed, it proceeds to unavailable-backup 607.

At write copy count information in the sub recording device 608, the media management file 509 holding the copy count information 510 therein having a value reduced from the copy count information 504 is written to the media file 508 inside the sub recording device 507.

Note that, the write operation of the media management file 509 is also required to be implemented to have tamper resistance by encrypting and the like with considering risks of hacking etc.

At write success 609, success or failure regarding to a writing of the media management file 509 is determined, and it proceeds to backup-unavailable 610 when the writing is failed. It proceeds to backup-end 611 when the writing is succeeded.

Next, a restore processing will be described. The restore processing can be performed by moving the media management file 509 of the media file 508 inside the main recording device 507 in FIG. 5 to the media management file 503 of the media file 502 inside the main recording device 501.

Note that, when the media file 502 is not destroyed, the copy count information 510 held in the media management file 509 of the media file 508 inside the sub recording device 507 may be added to the copy count information 504 held in the media management file 503 of the media file 502 inside the main recording device 501 to move the media management file 509 of the media file 508 inside the sub recording device 507 to the main recording device 501.

For example, in the case where the copy count information 501 indicates 5 times and the copy count information 504 before moving the media management file 509 to the main recording device 501 indicates 4 times, the copy count information 504 after moving the media management file 509 to the main recording device 501 becomes 9 times.

Consequently, when the state of the media file is the same with that at the time of backup, the copy count information can be restored to the state before backup by the restore processing.

As described above, in the present embodiment, the media file 502 is configured by the media data file 506 and the media management file 503, and the media management file 503 is backed up, so that the user can efficiently back up copy count information of a media file such as video, audio, image, text, map data, game data within a range of its copyright holder's permission.

Note that, while the media management file 503 of the media file 502 is backed up in the present embodiment, the media data file 506 may be copied to the sub recording device 507 with the media management file 503 similarly to the first embodiment.

In this case, since the sub recording device 507 records the media management file 509 and a media data file to which the media data file 506 is copied as the media file 508, it becomes possible to reproduce the media file 508 of the sub recording device 507. Further, backup to other recording devices also becomes possible based on information of copy count information 510 of the media management file 509.

In the foregoing, the invention made by the inventors of the present invention has been concretely described based on the embodiments. However, it is needless to say that the present invention is not limited to the foregoing embodiments and various modifications and alterations can be made within the scope of the present invention.

Although not shown, the programs realizing the backup processing and the restore processing as described above may be saved to a recorded media such as a floppy disk, CD, DVD, Blu-ray disk etc., or distributed to PCs and digital appliances via the Internet. The present invention is applicable to the recorded media and the distribution service.

The present invention is applicable to all information terminals requiring copyright protection and personal information protection for digital data such as recorded media of digital television broadcasting, map data, game data, etc.

What is claimed is:

1. A digital data recording device recording a media file configured by an encrypted media data file and a media management file containing decryption key information of the media data file that is a main body of digital contents, to a recording device, the digital data recording device comprising
a record control unit for backing up the media data file or the media management file to the recording device or a removable recording device, and restoring the media data file or the media management file backed up in the recording device or the removable recording device.

2. The digital data recording device according to claim 1 comprising a network control unit accessing to a network, wherein
the network control unit backs up the media data file or the media management file to an external recording device via the network, and restores the media data file or the media management file backed up in the external recording device via the network.

3. The digital data recording device according to claim 1, wherein
the media management file contains copy count information indicating a number of copyable times of the digital contents, and
the record control unit or the network control unit subtracts a predetermined number of times from the copy count information of a backup source upon backing up the media management file, and sets the predetermined number of times to the copy count information of a backup destination.

4. The digital data recording device according to claim 3, wherein
the record control unit or the network control unit adds the copy count information of the backed up media management file to the copy count information of the media management file of a restore destination upon restoring the media management file to set the copy count information.

5. The digital data recording device according to claim 1, wherein
the recording device and the removable recording device is an iVDR.
